(19) United States
(12) Patent Application Publication
(10) Pub. No.: US 2024/0244628 A1
(43) Pub. Date: Jul. 18, 2024

(54) METHOD AND DEVICE FOR SOLVING PUCCH TRANSMISSION AND DETERMINING PUCCH SLOT

(71) Applicant: ZTE Corporation, Shenzhen (CN)

(72) Inventors: Wei GOU, Shenzhen (CN); Junfeng ZHANG, Shenzhen (CN); Xianghui HAN, Shenzhen (CN); Shuaihua KOU, Shenzhen (CN)

(73) Assignee: ZTE Corporation, Shenzhen (CN)

(21) Appl. No.: 18/621,977

(22) Filed: Mar. 29, 2024

Related U.S. Application Data
(63) Continuation of application No. PCT/CN2022/088623, filed on Apr. 22, 2022.

(51) Int. Cl. H04W 72/21; H04L 1/1812; H04W 72/0446; H04W 72/12; H04W 72/566

(52) U.S. Cl. CPC H04W 72/21; H04L 1/1812; H04W 72/0446; H04W 72/12; H04W 72/566

(57) ABSTRACT

Methods, systems, and apparatuses for wireless communication are provided. The wireless communication includes determining, with a wireless access node and/or user equipment, a first slot for a first PUCCH and a second slot for a second PUCCH. In response, the wireless access node and/or user equipment processes the second PUCCH based on positions of the first slot and the second slot and a time domain position of the second PUCCH relative to the first PUCCH. The first PUCCH has a repetition factor greater than 1.

### CROSS-REFERENCE TO RELATED APPLICATIONS

This application is a continuation of International Application No. PCT/CN2022/088623, filed Apr. 22, 2022. The contents of International Application No. PCT/CN2022/088623 are herein incorporated by reference in their entirety.

### TECHNICAL FIELD

This document is directed generally to wireless communication where multiple transmissions may occur in a same slot.

### BACKGROUND

In time division duplex (TDD) systems, a slot may be used only downlink transmission or only for uplink transmission at a time. Correspondingly, downlink slots can only be used for downlink transmissions, and uplink slots can only be used for uplink transmissions. In contrast, when full duplexing is used, a slot can be used for both a downlink transmission and an uplink transmission. In general, the downlink transmission and the uplink transmission may be allocated different frequency resources.

### SUMMARY

This document relates to methods, systems, apparatuses, and devices for wireless communication. In some implementations, a method for wireless communication includes determining, with a wireless access node, a first slot for a first PUCCH and a second slot for a second PUCCH; and in response, processing, with the wireless access node, the second PUCCH based on positions of the first slot and the second slot and a time domain position of the second PUCCH relative to the first PUCCH, wherein the first PUCCH has a repetition factor greater than 1.

In some implementations, a method for wireless communication includes determining, with a User Equipment (UE), a first slot for a first PUCCH and a second slot for a second PUCCH; and in response, processing, with the UE, the second PUCCH based on a position of the first slot and the second slot and a time domain position of the second PUCCH relative to the first PUCCH, wherein the first PUCCH has a repetition factor greater than 1.

In some implementations, a method for wireless communication, includes configuring, with a wireless access node, PUCCH cell switching between a first cell and a second cell; and determining, with the wireless access node, a slot configured as a period position of a UCI PUCCH to be a PUCCH slot or not be a PUCCH slot based on a symbol type contained in the slot, wherein the symbol type comprises: a downlink symbol, an uplink symbol, or a flexible symbol, the slot is in one of the first cell or the second cell, and the UCI PUCCH comprises: HARQ-ACK, SR, or CSI.

In some implementations, a method for wireless communication includes determining, by a UE, PUCCH cell switching between first cell and second cell; and determining, by the UE, a slot configured as a period position of a UCI PUCCH to be a PUCCH slot or not be a PUCCH slot based on a symbol type contained in the slot, wherein the symbol type comprises: a downlink symbol, an uplink symbol, or a flexible symbol, the slot is in one of the first cell or the second cell, and the UCI PUCCH comprises: HARQ-ACK, SR, or CSI.

In some implementations, a wireless communications apparatus including processor and a memory, wherein the processor is configured to read code from the memory to implement any methods previously described.

In some implementations, a computer program product includes a computer-readable program medium comprising code stored thereupon, the code, when executed by a processor, causing the processor to implement any methods previously described.

In addition to the features mentioned in each of the independent aspects enumerated above, some examples may show, alone or in combination, the optional features mentioned in the dependent aspects and/or as disclosed in the description above and shown in the figures.

In some other implementations, a device, such as a network device, is disclosed. The device may include one or more processors and one or more memories, wherein the one or more processors are configured to read computer code from the one or more memories to implement the method above.

In yet some other implementations, a computer program product is disclosed. The computer program product may include a non-transitory computer-readable program medium with computer code stored thereupon, the computer code, when executed by one or more processors, causing the one or more processors to implement the method above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a diagram of an example slot format.

FIG. 3 shows an example wireless communication occurring over a plurality of slots.

FIG. 4 shows an example wireless communication occurring over a plurality of slots.

FIG. 5 shows flow chart of an example method of wireless communication.

FIG. 6 shows flow chart of an example method of wireless communication.

FIG. 7 shows flow chart of an example method of wireless communication.

FIG. 8 shows flow chart of an example method of wireless communication.

FIG. 9 shows flow chart of an example method to determine a PUCCH slot.

FIG. 10 shows flow chart of an example method to determine a PUCCH slot.

FIG. 11 shows flow chart of an example method to determine a PUCCH slot.

FIG. 12 shows flow chart of an example method to determine a PUCCH slot.

FIG. 13 shows flow chart of an example method to determine a PUCCH slot.

FIG. 14 shows flow chart of an example method to determine a PUCCH slot.

### DETAILED DESCRIPTION

The present description describes various embodiments of systems, apparatuses, devices, and methods for wireless communications involving scheduling signal transmission.

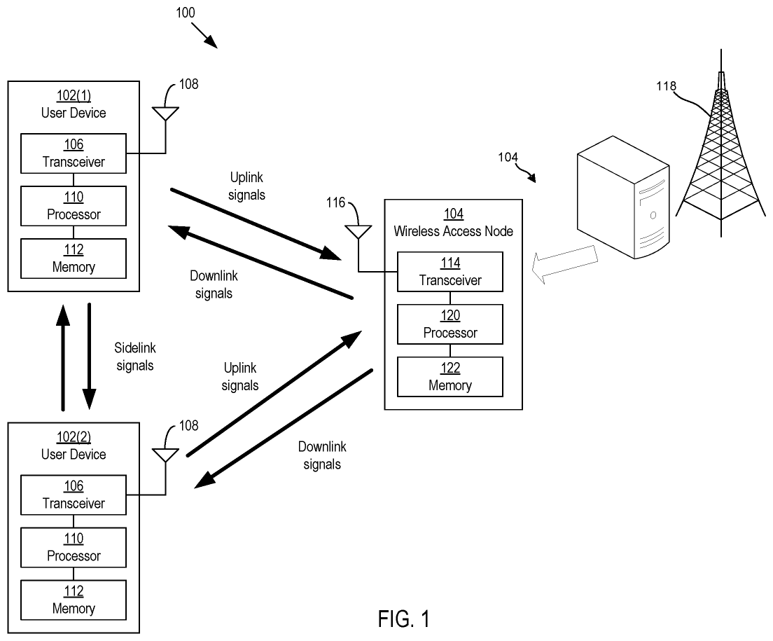

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access nodes 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to a another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

Additionally, in the wireless communication system 100, a slot format for a plurality of slots or frames can be configured by the wireless access node 104 or specified by a protocol. In some examples, a slot can be indicated or specified as a downlink slot, a flexible slot, or an uplink slot. Also, an orthogonal frequency divisional multiplexing (OFDM) symbol may be indicated or specified as a downlink symbol, a flexible symbol, or an uplink symbol, in various embodiments.

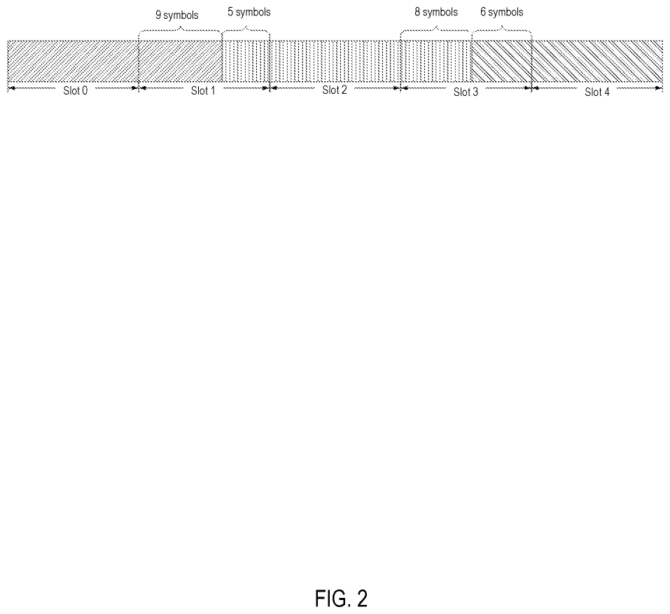

FIG. 2 is a diagram of an example slot format. In FIG. 2, for example, five slots are shown, denoted by Slot 0, Slot 1, Slot 2, Slot 3, and Slot 4. The symbols of Slot 0 and the first nine symbols in Slot 1 are configured as downlink symbols. Accordingly, a downlink (DL) bandwidth part (BWP) includes these symbols/slots. Also, the last five symbols in the Slot 1, the symbols of Slot 2, and the first eight symbols in Slot 3 are configured as flexible symbols (i.e., they are used as uplink or downlink transmission symbols). Additionally, the last six symbols in Slot 3 and the symbols in Slot 4 are configured as uplink symbols. Accordingly, an uplink (UP) BWP includes these symbols/slots.

In various embodiments, the wireless access node 104 may configure a plurality of first resources for a user device 102. A configuration for the first resource may include or identify at least one of a period, a time offset, a number of slots, an OFDM symbol location, an OFDM symbol pattern, a sub-carrier location, a sub-carrier pattern, a number of resource blocks (RB), a starting RB, a frequency offset, a number of ports, a code division multiplexing (CDM) type, or a density.

In further detail, the period is the interval between two consecutive occasions of the first resource. The time offset is the interval between the boundary of a first system frame (e.g., the boundary of Slot 0 in system frame number (SFN) 0) and the first occasion of the first resource. The number of slots is the number of consecutive slots occupied by a resource occasion. The OFDM symbol location or the OFDM symbol pattern indicates the symbols in a slot occupied by a resource occasion. The sub-carrier location indicates the sub-carriers in an RB occupied by the first resource. The start RB indicates the first RB index (or number) of the resource occasion. The frequency offset is the interval between the first RB of the resource occasion and the lowest RB of a bandwidth part (or the system channel bandwidth, or common radio block). The number of RBs indicates the RBs occupied by the first resource. The density indicates the number of sub-carriers per RB per port.

Also, in various embodiments, the first resource may be periodic, semi-persistent, or aperiodic. For the periodic first resource, the resource occasion occurs periodically after being configured by the wireless access node 104. A semi-persistent first resource is activated or de-activated by the wireless access node via a medium access control (MAC) control element (CE) or a DCI. After a semi-persistent first resource is activated by the wireless access node 104, the resource occasions of the first resource occur periodically until the semi-persistent first resource is de-activated by the wireless access node 104.

An aperiodic first resource is triggered by the wireless access node 104 via a DCI. After an aperiodic first resource is triggered by the wireless access node 104, the resource occasion occurs once. For an aperiodic first resource, the triggering field is included in a DCI. The offset (or interval) between the DCI and the resource occasion is configured by the wireless access node 104. For example, the offset is k slots. If the DCI triggering the first resource is transmitted on a slot n, then the first resource occurs on slot n+k. Alternatively, the DCI schedules a transmission, and the resource occasion occurs in the slot of the scheduled transmission. The transmission may be a downlink transmission, an uplink transmission, or a sidelink transmission. For example, if the DCI transmitted on slot n schedules an uplink transmission on a slot m and triggers a first resource, the first resource occurs on slot m.

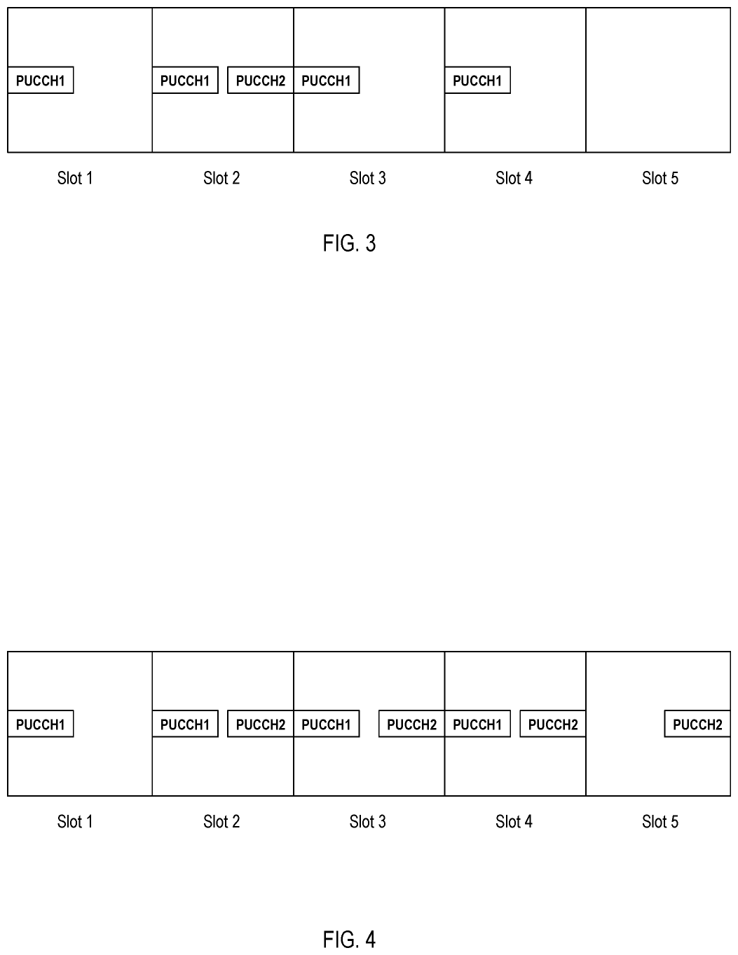

FIG. 3 illustrates diagram of an example of a plurality of first resource occasions. As shown in the example of FIG. 3, a system frame includes ten slots, denoted by Slot 0-Slot 9. The configured period of the first resource is 40 slots. The time offset is 4 slots, which is relative to the first slot of SFN 0 (i.e., Slot 0). The wireless access node configures 30 physical resource blocks (PRB) for the first resource. Additionally, the wireless access node 104 configures three slots for the first resource. The frequency offset is 10 PRB, which is relative to the lowest PRB of the BWP. Also, the lowest PRB of the BWP is PRB 0.

For embodiments where the first resource is a periodic first resource, the resource occasion of the first resource occurs periodically. For example, FIG. 3 shows seven resource occasions. The first resource occasion occupies Slot 4, Slot 5 and Slot 6 of system frame 0 in the time domain, and 30 PRB (from PRB 10 to PRB 39 PRB) in the frequency domain. The second resource occasion occupies Slot 4, Slot 5, and Slot 6 of system frame 4 in the time domain, and 30 PRBs (from PRB 10 to PRB 39 PRB) in the frequency domain. The third, fourth, fifth, sixth, and seventh resource occasions are in system frames 8, 12, 16, 20, and 24, respectively.

For embodiments where the first resource is a semi-persistent first resource, assuming, as an example, that the first resource is activated before the first resource occasion and de-activated before the fifth resource occasion, then there are only 4 resource occasions for the semi-persistent first resource—i.e., the first, second, third, fourth resource occasions. FIGS. 3 and 4 illustrate examples of non-overlapping PUCCHs within one or more common slots. For a cell, the PUCCH resource of the scheduling request (SR) may be configured with a repetition factor N, where N is a positive integer. If the N corresponding to an SR PUCCH is greater than one, and if the SR is positive, the UE may send the SR PUCCH in the corresponding determined slot based on the SR configuration information when it is the first SR PUCCH transmission. For the remaining N−1 SR PUCCH transmissions in the cell, the corresponding slot may be determined from the cell according to the following conditions, including: (1) An uplink symbol or flexible symbol may be provided in a slot, and the uplink symbol or flexible symbol has the same index as the first SR PUCCH transmission of the SR; and (2) Consecutive UL symbols or flexible symbols may be provided in one slot, and the starting symbol of the consecutive symbols may be the same as the first symbol of the first SR PUCCH transmission, and the number of consecutive symbols may be greater than or equal to the number of the first SR PUCCH transmission. If the slot satisfies the aforementioned two conditions, the slot may be determined as the slot for transmitting the SR PUCCH, and the remaining SR PUCCH may be transmitted in the slot by using the same SR PUCCH resources as the first SR PUCCH transmission.

A PUCCH with a repetition factor greater than one (e.g., transmitted over more than one slot) may overlap with other PUCCHs in the time domain. More specifically, if a UE 102 transmits a first PUCCH over more than one slot and at least a second PUCCH over one or more slots, and the transmission of the first PUCCH and the second PUCCH would overlap for one or more slots, then, for each slot where the UCI type priority of HARQ-ACK>SR>CSI with higher priority>CSI with lower priority: (1) the UE 102 may not expect the first PUCCH and any of the second PUCCHs to start at a same slot and include a UCI type with a same priority; (2) if the first PUCCH and any of the second PUCCHs include a UCI type with a same priority, the UE may transmit the PUCCH that occurs at the earlier slot and may not transmit subsequent PUCCHs that occur at later slot(s); and (3) if the first PUCCH and any of the second PUCCHs do not include a UCI type with a same priority, the UE 102 may transmit the PUCCH having the UCI type with a higher priority and may not transmit the PUCCH having the UCI type with a lower priority. For instance, a UE 102 may transmit at least two PUCCHs (e.g., PUCCH1 and PUCCH2) having a UCI of a same UCI type priority that begin in different slots, where PUCCH1 is repeated for one or more additional slots and occurs before PUCCH2 in each slot. The UE 102 may drop transmission of the subsequent PUCCH2 in every slot where transmission of the PUCCH2 would overlap with a repetition of the earlier PUCCH1 transmission.

A physical layer priority indication, referred to as a PHY priority, may be introduced into the physical layer. A high PHY priority and a low PHY priority may exist. Within a same slot, a PUCCH with a high PHY priority and a PUCCH with a low PHY priority may be transmitted when there is no overlap in the time domain. In a slot, only one HARQ-ACK PUCCH may be allowed to transmit for HARQ-ACK PUCCHs having the same PHY priority (without UL subslot configured).

When an SPS HARQ-ACK meets the following conditions, the SPS HARQ-ACK may be delayed for feedback if the SPS is configured with delayed feedback: after UCI multiplexing (if any), any symbol of the PUCCH carrying the SPS HARQ-ACK overlaps with a symbol indicated as downlink by tdd-UL-DL-ConfigurationCommon or tdd-UL-DL-ConfigDedicated, or indicated for an SS/PBCH block by ssb-PositionsInBurst, or belonging to a CORESET associated with a Type0-PDCCH CSS set. Then, the SPS HARQ-ACK may be performed with delayed feedback in accordance with TS38.213.

As shown in the example of FIG. 3, a PUCCH1 is configured with a repetition factor of 4. The first repetition of PUCCH1 is transmitted in Slot 1. The second repetition of PUCCH1 is transmitted in Slot 2. The third repetition of PUCCH1 is transmitted in Slot 3. The fourth repetition of PUCCH1 is transmitted in Slot 4. However, in Slot 2, a PUCCH2 with a repetition factor of 1 is triggered for transmission. The PUCCH2 and PUCCH1 do not overlap in the time domain, have the same PHY priorities, and the same or different UCI type priorities. In this example, the behavior of the UE 102 under these circumstances may not be well-defined or predictable.

In the example of FIG. 4, a PUCCH1 is configured with a repetition factor of 4. The first repetition of PUCCH1 is transmitted in Slot 1. The second repetition of PUCCH1 is transmitted in Slot 2. The third repetition of PUCCH1 is transmitted in Slot 3. The fourth repetition of PUCCH1 is transmitted in Slot 4. Similarly, in slot 2, a PUCCH2 with a repetition factor of 4 is triggered for transmission. The PUCCH2 and PUCCH1 transmission do not overlap in the time domain, have the same PHY priorities, and the same or different UCI type priorities. Again, in this example, the behavior of the UE 102 under these circumstances may not be well-defined or predictable.

The present subject matter may provide a solution to solve the problems identified with reference to FIGS. 3 and 4. When a UE 102 transmits a PUCCH1 with a repetition factor greater than 1, the slots for the PUCCH1 repetitions should be determined based on existing rules provided in the standards previously identified. It may be assumed that the determined slots for PUCCH1 are identical as shown in FIG. 4 (i.e., Slot 1-Slot 4). A PUCCH2 may be dynamically scheduled or semi-statically configured for transmission in any of Slot 1, Slot, Slot 3, or Slot 4, where the PUCCH2 and PUCCH1 repetitions do not overlap in the time domain. The behavior of the wireless access node 104 and/or UE 102 may be specified as follows.

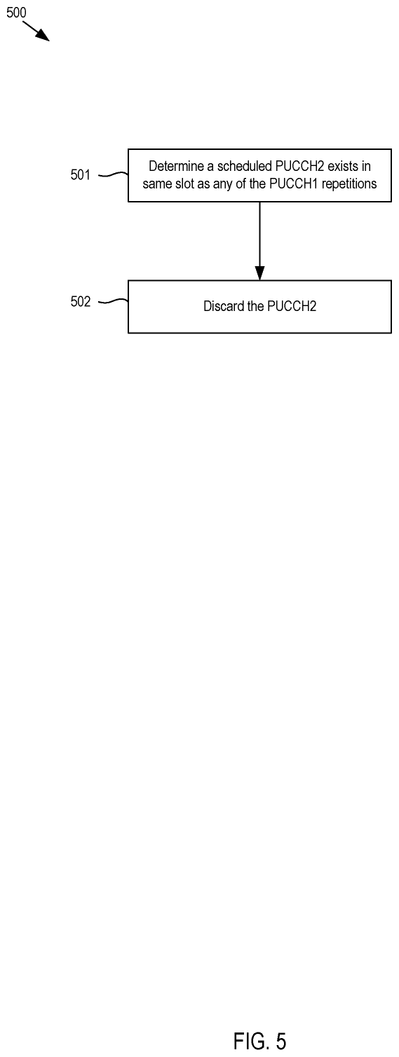

FIG. 5 is a flow chart of an example method 500 for wireless communication that at least one wireless access node 104 may perform. In the wireless access node 104 for example, where the PUCCH2 may be dynamically scheduled by a PDCCH and the wireless access node 104 schedules the PUCCH2 in one or more same slots scheduled for the PUCCH1 repetitions in 501, the PUCCH2 cannot be non-overlapping in the time domain with the PUCCH1 repetition in the same slot. If the PUCCH1 repetitions will be transmitted in Slots 1-4, and if the wireless access node 104 dynamically schedules a PUCCH2 in any of Slots 1-4, the wireless access node 104 may avoid the issue of non-overlap. Specifically, where the dynamically-scheduled PUCCH2 does overlap in the time domain with any of the PUCCH1 repetitions in Slots 1-4, the PUCCH2 may be discarded in 502. Alternatively, or in addition, the wireless access node 104 may not dynamically schedule the PUCCH2 in any slots where a PUCCH1 repetition(s) is determined to occur and/or the PUCCH2 would be non-overlapping in the time domain with the PUCCH1 repetition(s).

A similar behavior may be specified for the wireless access node 104 in an example where PUCCH2 may be configured for RRC signaling (without PDCCH). In this example, if the wireless access node 104 configures a PUCCH2 in one or more same slots determined for a PUCCH1 repetition, then the PUCCH2 cannot be non-overlapping in the time domain with the PUCCH1 repetition in the same slot. If PUCCH1 repetitions will be transmitted in Slots 1-4, and if the wireless access node 104 configures a PUCCH2 in any of Slots 1-4, the wireless access node 104 may avoid the issue of non-overlap. Specifically, where the configured PUCCH2 does overlap with any of the PUCCH1 repetitions in Slots 1-4, the PUCCH2 may be discarded. Alternatively, or in addition, the wireless access node 104 may not configure the PUCCH2 in any slots where a PUCCH1 repetition(s) is determined to occur and/or the PUCCH2 would be non-overlapping in the time domain with the PUCCH1 repetition(s).

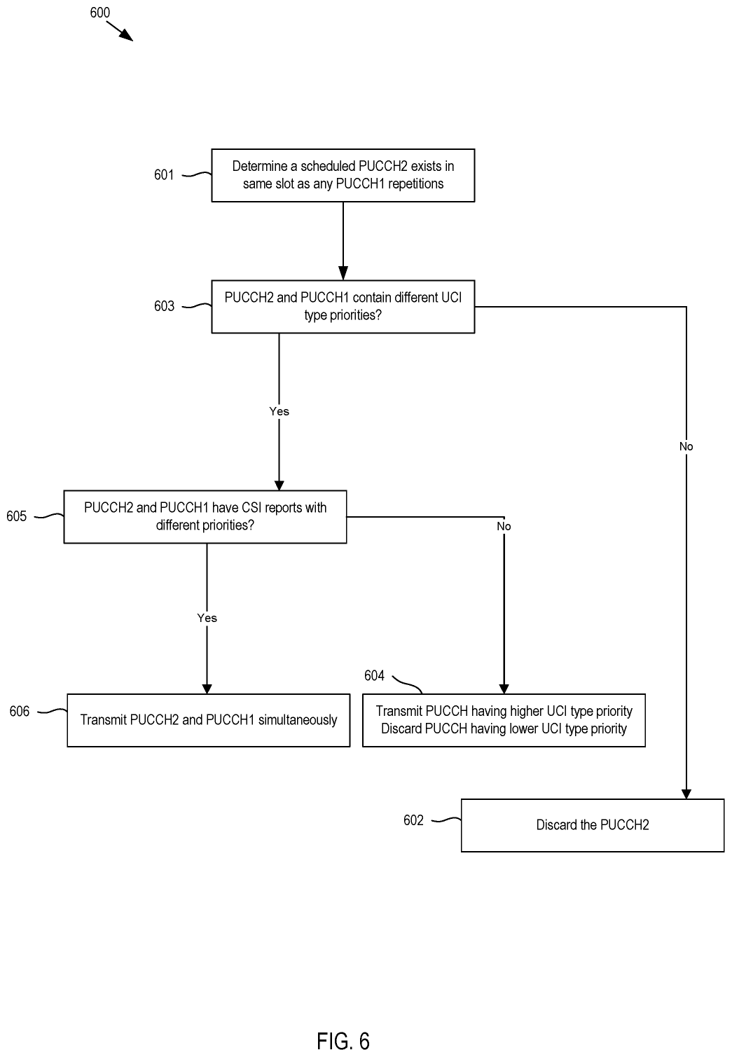

FIG. 6 is a flow chart of an example method 600 for wireless communication that at least one UL 102 may perform. As for the UE 102, where the UE 102 determines in 601 that PUCCH1 repetitions will be transmitted in Slots 1-4 and a PUCCH2 is dynamically scheduled in any of Slots 1-4, the UE 102 may not expect the PUCCH2 and the PUCCH1 repetitions to be non-overlapping in the time domain. Alternatively, or in addition, the UE 102 may not expect that the PUCCH2 will be scheduled in any of Slots 1-4. If the PUCCH2 is scheduled in any of Slots 1-4, the UE 102 may accept that the PUCCH2 and the PUCCH1 repetitions overlap in the time domain and discard the PUCCH2 in 602.

A similar behavior may be specified for the UE 102 in an example where the PUCCH2 may be configured for RRC signaling (without PDCCH). In this example, if the UE 102 determines that the PUCCH1 repetitions will be transmitted in Slots 1-4 and the PUCCH2 is dynamically scheduled for any of Slots 1-4, the UE 102 may not expect the PUCCH2 and PUCCH1 repetitions to be non-overlapping in the time domain. Alternatively, or in addition, the UE 102 may not expect the PUCCH2 to be scheduled in any of Slots 1-4. If the PUCCH2 is scheduled in any of Slots 1-4, the UE 102 may accept that the PUCCH2 and PUCCH1 repetitions overlap in the time domain and discard the PUCCH2.

The PUCCH2 may have a repetition factor greater than 1 or equal to 1 (i.e., a single slot PUCCH). The PUCCH2 and PUCCH1 may contain the same UCI type priority. If the PUCCH2 and the PUCCH1 contain different UCI type priorities as determined in 603, the PUCCH having the higher UCI type priority may be transmitted and the other PUCCH having the lower UCI type priority may be discarded in 504. Alternatively, or in addition, where the PUCCH2 and PUCCH1 have different UCI type priorities as determined in 605, the PUCCH2 and PUCCH1 may be transmitted simultaneously in 606, especially if the PUCCH2 and PUCCH1 have CSI reports with different priorities.

In these specified behaviors for the wireless access node 104 and UE 102, the wireless access node 104 may be required to ensure that a PUCCH2 is not dynamically scheduled in any slots where a PUCCH1 repetition(s) is determined to occur and/or the PUCCH2 would be non-overlapping with the PUCCH1 repetition(s). Configuring the wireless access node 104 in this way may be complicated especially with respect to the periodic position of the semi-static PUCCH2.

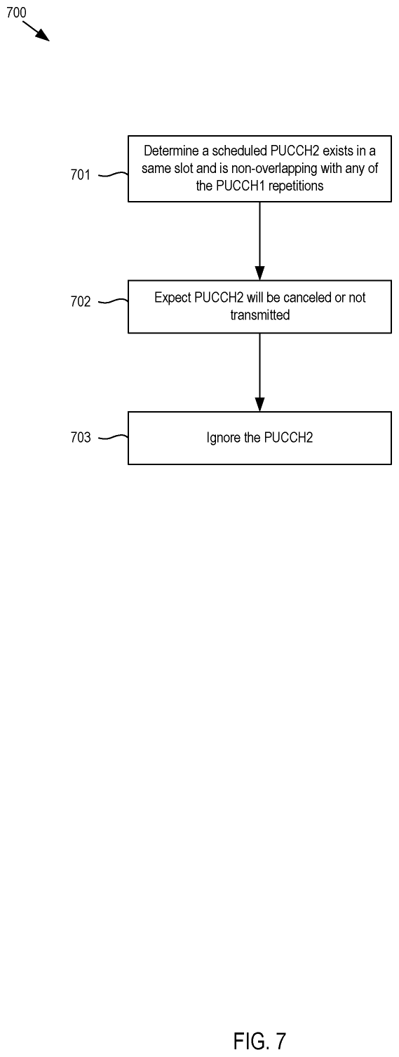

FIG. 7 is a flow chart of an example method 700 for wireless communication that at least one wireless access node 104 may perform. The behavior of the wireless access node 104 may also be specified as follows. Where the PUCCH2 may be dynamically scheduled by a PDCCH and the wireless access node 104 schedules the PUCCH2 in one or more same slots determined for a PUCCH1 repetition such that the PUCCH2 and PUCCH1 repetition(s) are non-overlapping in the time domain, the wireless access node 104 may expect the PUCCH2 to be canceled or not transmitted at all. Specifically, if the PUCCH1 repetitions will be transmitted in Slots 1-4, and if the wireless access node 104 dynamically schedules a PUCCH2 in any of Slots 1-4 such that the PUCCH2 and PUCCH1 repetitions are non-overlapping in the time domain, the wireless access node 104 may expect in 702 that the PUCCH2 will be canceled or expect that the PUCCH2 will not be transmitted at all. Stated another way, the wireless access node 104 may ignore the PUCCH2 in this circumstance in 703.

A similar behavior may be specified for the wireless access node 104 in an example where the PUCCH2 may be configured for RRC signaling (without PDCCH). In this example, if the wireless access node 104 dynamically schedules a PUCCH2 in one or more same slots determined for a PUCCH1 repetition such that the PUCCH2 and PUCCH1 repetition(s) are non-overlapping in the time domain, the wireless access node 104 may expect the PUCCH2 to be canceled or not transmitted at all. Specifically, if the PUCCH1 repetitions will be transmitted in Slots 1-4, and if the wireless access node 104 dynamically schedules a PUCCH2 in any of Slots 1-4 such that the PUCCH2 and PUCCH1 repetitions are non-overlapping in the time domain, the wireless access node 104 may expect that the PUCCH2 will be canceled or expect that the PUCCH2 will not be transmitted at all.

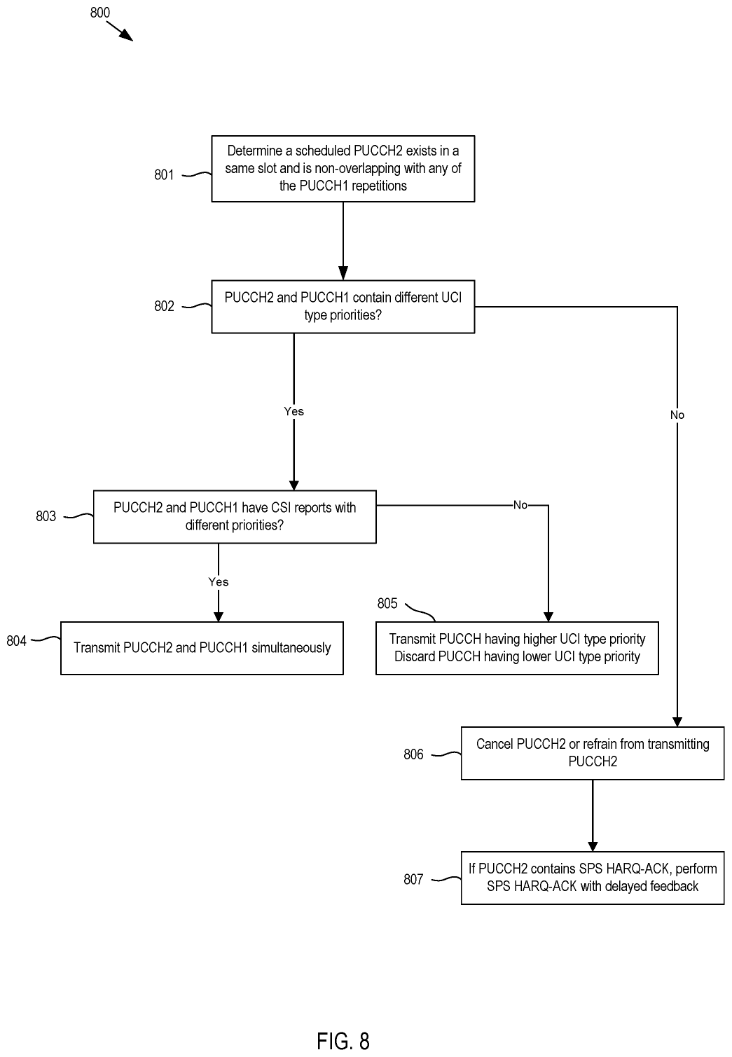

FIG. 8 is a flow chart of an example method 800 for wireless communication that at least one UL 102 may perform. As for the UE 102, where a PUCCH2 is scheduled in one or more same slots determined for a PUCCH1 repetition such that the PUCCH2 and PUCCH1 repetition(s) are non-overlapping in the time domain in 801, the UE 102 may cancel the PUCCH2 or refrain from transmitting the PUCCH2 in 802. Specifically, where the UE 102 determines that PUCCH1 repetitions will be transmitted in Slots 1-4 and the wireless access node 104 dynamically schedules a PUCCH2 in any of Slots 1-4 such that the PUCCH2 and PUCCH1 repetitions are non-overlapping in the time domain, the UE 102 may cancel the PUCCH2 or refrain from transmitting the PUCCH2 in 806.

A similar behavior may be specified for the UE 102 in an example where the PUCCH2 may be configured for RRC signaling (without PDCHH). In this example, where a PUCCH2 is scheduled in one or more same slots determined for a PUCCH1 repetition such that the PUCCH2 and PUCCH1 repetition(s) are non-overlapping in the time domain, the UE 102 may cancel the PUCCH2 or refrain from transmitting the PUCCH2. Specifically, when the UE 102 determines that PUCCH1 repetitions will be transmitted in Slots 1-4 and the wireless access node 104 dynamically schedules a PUCCH2 in any of Slots 1-4 such that the PUCCH2 and PUCCH1 repetitions are non-overlapping in the time domain, the UE 102 may cancel the PUCCH2 or refrain from transmitting the PUCCH2.

The PUCCH2 may have a repetition factor greater than or equal to 1 (i.e., a single slot PUCCH). The PUCCH2 and PUCCH1 may contain the same UCI type priority. If the PUCCH2 and PUCCH1 contain different UCI type priorities as determined in 802, the PUCCH having the higher UCI type priority may be transmitted and the other PUCCH having the lower UCI type priority may be discarded in 805. For example, the wireless access node 104 may expect the PUCCH with the higher UCI type priority to be transmitted between PUCCH1 and PUCCH2, where the other PUCCH may be dropped. The UE 102 may transmit the PUCCH having the higher UCI type priority between PUCCH1 and PUCCH2, where the other PUCCH may be dropped. Alternatively, or in addition, if PUCCH2 and PUCCH1 contain different UCI type priorities, the two PUCCHs may be transmitted simultaneously in 804, especially if PUCCH2 and PUCCH1 have CSI reports with different priorities as determined in 803. For instance, the wireless access node 104 may expect PUCCH2 and PUCCH1 to be transmitted simultaneously if PUCCH2 and PUCCH1 are non-overlapping in the time domain and contain different UCI type priorities. The UE 102 may transmit PUCCH2 and PUCCH1 if both are non-overlapping in the time domain and contain different UCI type priorities.

In the above example and in all approaches described herein, the PUCCH2 may be dynamically scheduled by PDCCH or semi-statically configured by RRC signaling (without PDCCH). The PUCCH2 may be dynamically scheduled in a slot based on DCI in the PDCCH. The dynamically scheduled PUCCH2 may include one of the following: a HARQ-ACK PUCCH (in response to a dynamically scheduled PDSCH), and a HARQ-ACK PUCCH (in response to a PDCCH without a corresponding PDSCH). The PUCCH2 may also be semi-statically configured (without a corresponding PDCCH) so that the PUCCH2 is configured to transmit in a slot based on RRC signaling. The semi-statically configured PUCCH2 may include one of the following: SPS HARQ-ACK PUCCH, SR PUCCH, and CSI PUCCH.

As previously described, in some cases the PUCCH2 may be canceled. If the PUCCH2 contains an SPS HARQ-ACK corresponding to an SPS configured with delayed feedback, the following technique may be considered for the SPS HARQ-ACK. It may be assumed that a PUCCH2 containing SPS HARQ-ACK corresponding to the SPS is determined to be transmitted in a Slot n. If the PUCCH2 is canceled for transmission because a PUCCH1 repetition and the PUCCH2 are non-overlapping in the time domain in Slot n, then the SPS HARQ-ACK may be performed with delayed feedback in 807. The specific delayed feedback may be performed according to the TS38.213 specification. A new trigger condition may be introduced for the existing SPS HARQ-ACK delay feedback. If a PUCCH2 containing an SPS HARQ-ACK is canceled because the PUCCH2 and a PUCCH1 repetition are non-overlapping in the time domain in a same slot, then the SPS HARQ-ACK may be performed with delayed feedback. In any of the previously-described techniques, if the canceled PUCCH2 contains the SPS HARQ-ACK of the SPS configured for delayed feedback, the SPS HARQ-ACK may perform delayed feedback.

The wireless access node 104 may configure an SPS with delayed feedback for the UE 102. If the wireless access node 104 determines that a PUCCH2 including SPS HARQ-ACK corresponding to the SPS is canceled for transmission because a PUCCH1 repetition and the PUCCH2 are non-overlapping in the time domain in a same slot, then the wireless access node 104 may expect the SPS HARQ-ACK to be performed with delayed feedback according to the TS38.213 specification. The UE 102 may be configured with an SPS with delayed feedback. If a PUCCH2 including an SPS HARQ-ACK corresponding to the SPS is canceled for transmission because a PUCCH1 repetition and the PUCCH2 are non-overlapping in the time domain in a same slot the SPS HARQ-ACK may be performed with delayed feedback according to the TS38.214 specification.

Determining whether a slot is a PUCCH slot, where the periodic position of the UCI PUCCH is located, may occur according to the following rules. If the PUCCH of the multiplexing result is an invalid PUCCH in a slot configured with UCI PUCCH after UCI multiplexing is performed, then the slot may be determined to not be a PUCCH slot. Otherwise, the slot is determined to be a PUCCH slot. As used herein, an invalid PUCCH refers to when a PUCCH overlaps with downlink symbols, SSB symbols, or CORESET #0 symbols in the time domain. The UE 102 may perform UCI multiplexing fist and then determine whether the slot is a PUCCH slot according to the aforementioned rules, which may be complicated. If it is determined that the slot is not a PUCCH slot, then the UE 102 may demultiplex and re-execute the multiplexing in another slot.

According to the present subject matter, an approach for PUCCH cell switching is provided. The approach includes proposed rules for determining whether a slot is a PUCCH slot and a proposed rule for UCI multiplexing when PUCCH cell switching is configured between PCell and SCell.

If PUCCH cell switching is configured for the UE 102, the wireless access node 104 and/or UE 102 may determine the PUCCH slot between PCell and SCell. Specifically, the wireless access node 104 and/or UE 102 may determine whether a slot configured with UCI PUCCH may be used as a PUCCH slot based on the attributes or slot type of the symbols contained in a slot. The attributes of symbols may include downlink symbols, uplink symbols, or flexible symbols. The slot types may include a downlink slot (i.e., all symbols contained in the slot are downlink symbols), an uplink slot (i.e., all symbols contained in the slot are uplink symbols), and flexible slots (i.e., contains at least one flexible symbol). UCI includes HARQ-ACK, SR, or CSI.

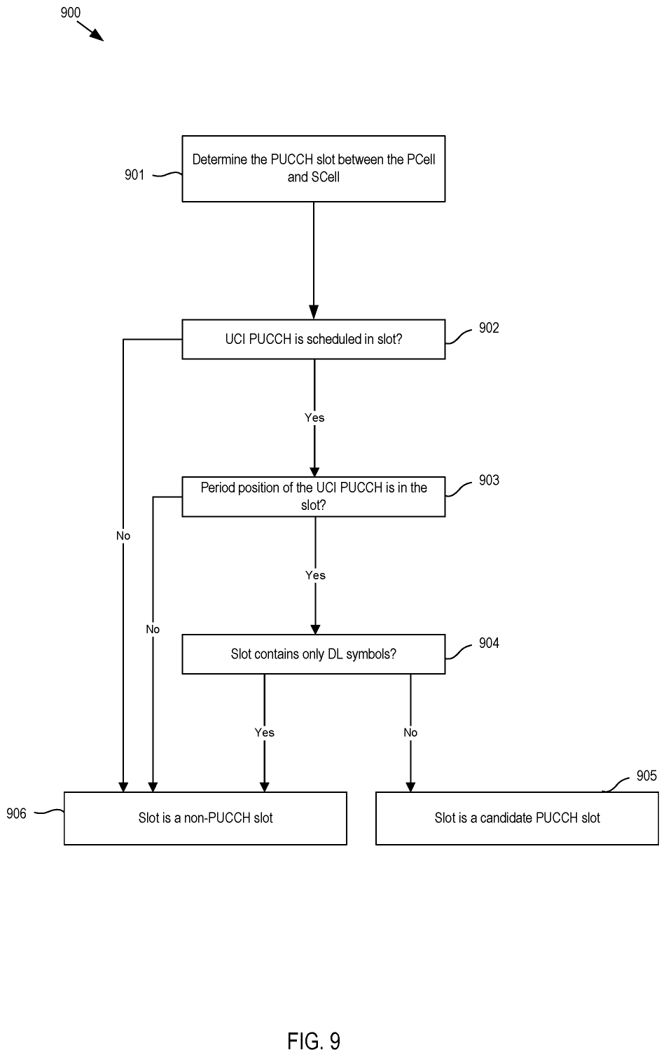

In connection with FIG. 9, a first rule 900 for determining the PUCCH slot between the PCell and SCell in 901 is now described. In a PCell and/or an SCell, when it is determined that a slot that contains only downlink symbols in 904, that a UCI PUCCH is scheduled in 902, and that the period position of the UCI PUCCH is in the slot in 903, then the slot may not be determined to be a PUCCH slot (a non-PUCCH slot) in 906. Another slot overlapping the non-PUCCH slot in the time domain may be allowed to be configured as a PUCCH slot (905). For example, an SR/SPS HARQ-ACK/CSI may be configured, and the period position of the SR/SPS HARQ-ACK/CSI PUCCH may be in the PCell or SCell in Slot n. All symbols contained in Slot n may be downlink symbols. Slot m in the SCell or PCell may be a UL slot, and Slot m and Slot n may overlap in the time domain. If the wireless access node 104 attempts to configure a PUCCH slot from Slot n and Slot m, then the wireless access node 104 should configure Slot m as a PUCCH slot. Both the wireless access node 104 and the UE 102 may determine that Slot n cannot be considered a PUCCH slot, even if Slot n is the slot where the period position of the SR/SPS HARQ-ACK/CSI PUCCH is located (903), because according to this first rule, all symbols contained in Slot n are DL symbols (904). Therefore, Slot n may not be considered a PUCCH slot (906).

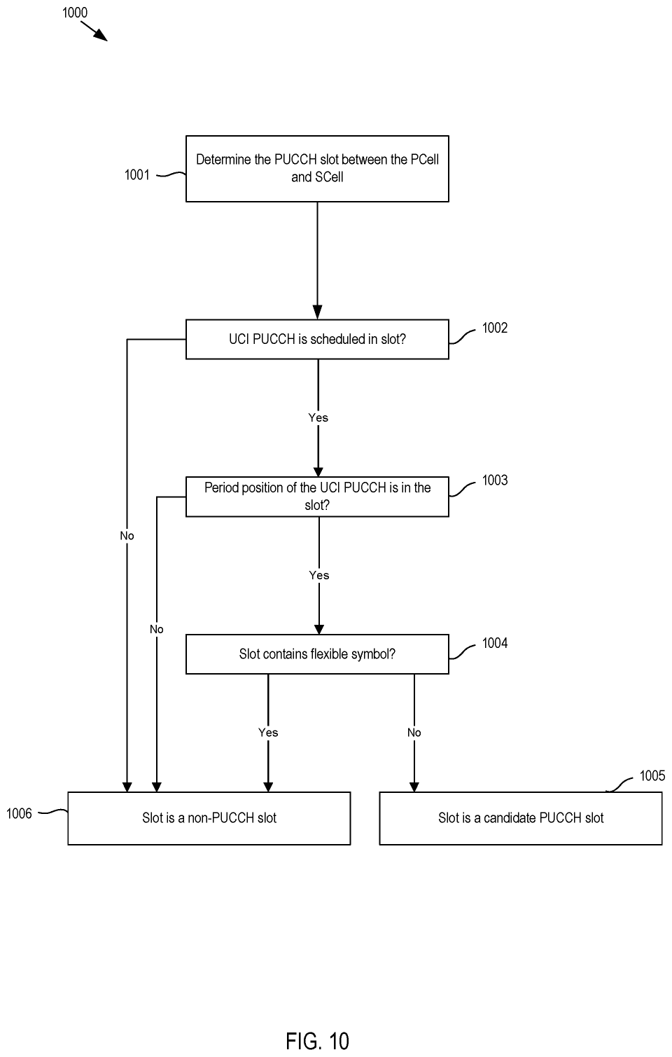

In connection with FIG. 10, a second rule 1000 for determining the PUCCH slot between the PCell and SCell 1001 is now described. In a PCell and/or an SCell for a slot that contains at least one flexible symbol in 1004, if a UCI PUCCH is scheduled in 1002, and the period position of the UCI PUCCH is in the slot in 1003, then the slot may be determined to be a non-PUCCH slot (1006). Another slot overlapping the non-PUCCH slot in the time domain may be allowed to be configured as a PUCCH slot (1005). For example, an SR/SPS HARQ-ACK/CSI may be configured (1002), and the period position of the SR/SPS HARQ-ACK/CSI PUCCH may be in the PCell or SCell in Slot n (1003). Slot n may contain at least one flexible symbol (1004). Slot m in the SCell or PCell may be a UL slot, and Slot m and Slot n may overlap in the time domain. If the wireless access node 104 attempts to configure a PUCCH slot from Slot n and Slot m, then the wireless access node 104 should configure Slot m as a PUCCH slot. Both the wireless access node 104 and the UE 102 may determine that Slot n cannot be considered a PUCCH slot, even if Slot n is the slot where the period position of the SR/SPS HARQ-ACK/CSI PUCCH is located (1003, because according to this second rule, Slot n contains at least one flexible symbol (1004). Therefore, Slot n may not be considered a PUCCH slot (1006).

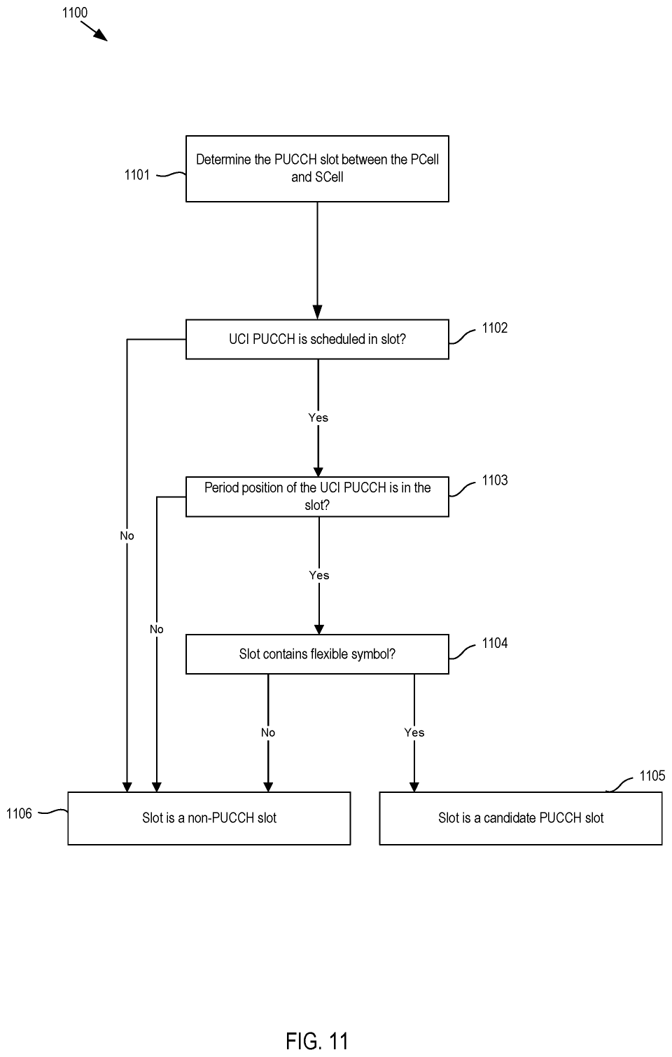

In connection with FIG. 11, a third rule 1100 for determining the PUCCH slot between the PCell and SCell is now described. In a PCell and/or an SCell for a slot that contains at least one flexible symbol in 1104, if a UCI PUCCH is scheduled in 1102, and the period position of the UCI PUCCH is in the slot in 1103, then the slot may be determined to be a PUCCH slot (1105). Another slot in the time domain overlapping the PUCCH slot is not allowed to be configured as a PUCCH slot (1106). For example, an SR/SPS HARQ-ACK/CSI may be configured (1102), and the period position of the SR/SPS HARQ-ACK/CSI PUCCH may be in the PCell or SCell in Slot n (1103). Slot n may contain at least one flexible symbol (104). Slot m in the SCell or PCell may be a UL slot, and Slot m and Slot n may overlap in the time domain. If the wireless access node 104 attempts to configure a PUCCH slot from Slot n and Slot m, then the wireless access node 104 should configure Slot n as a PUCCH slot (1105). Both the wireless access node 104 and the UE 102 may determine that Slot m cannot be considered a PUCCH slot because according to this third rule, Slot n contains at least one flexible symbol (1104) and is the slot where the period position of SR/SPS HARQ-ACK/CSI PUCCH is located. Therefore, Slot n may be considered a PUCCH slot (1105).

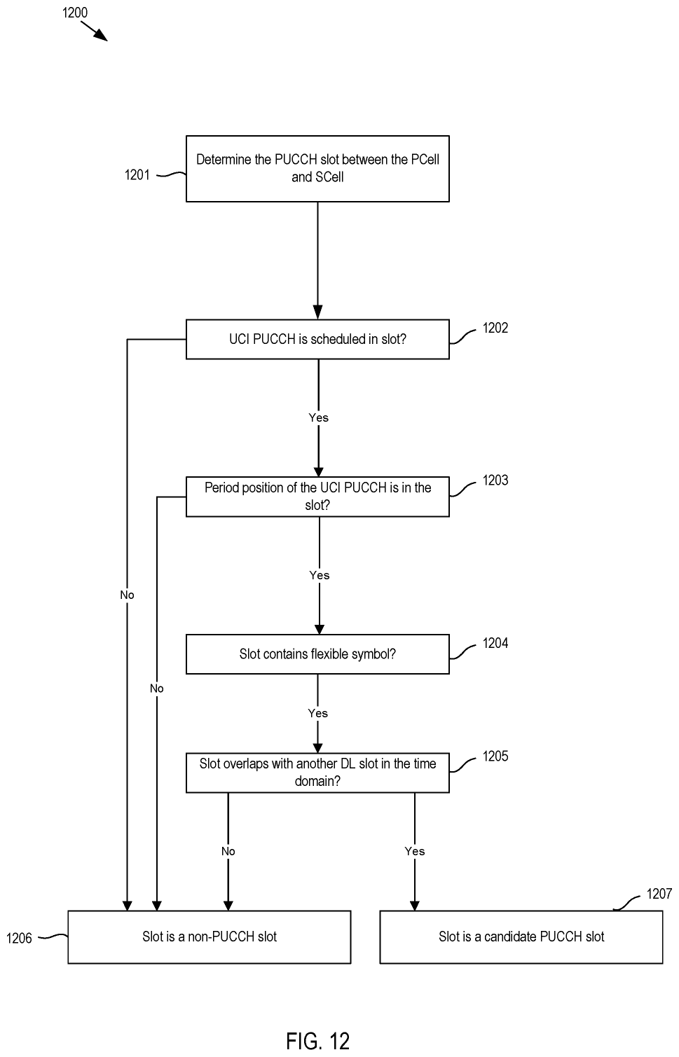

In connection with FIG. 12, a fourth rule 1200 for determining the PUCCH slot between the PCell and SCell is now described. In a PCell and/or an SCell for a slot containing at least one flexible symbol in 1204, if a UCI PUCCH is scheduled in 1202, the period position of the UCI PUCCH is in the slot in 1203, and if the slot overlaps with another DL slot in the time domain in 1205, then the slot may be determined to be a PUCCH slot in 1207. Another slot in the time domain overlapping the PUCCH slot may not be allowed to be configured as a PUCCH slot (1206). For example, an SR/SPS HARQ-ACK/CSI may be configured (1202), and the period position of the SR/SPS HARQ-ACK/CSI PUCCH may be in the PCell or SCell in Slot n (1203). Slot n may contain at least one flexible symbol (1204). Slot m in the SCell or PCell may be a DL slot, and Slot m and Slot n may overlap in the time domain (1205). If the wireless access node 104 attempts to configure a PUCCH slot from Slot n and Slot m, then the wireless access node 104 should configure Slot n as a PUCCH slot. Both the wireless access node 104 and the UE 102 may determine that Slot m cannot be considered a PUCCH slot because according to this fourth rule, Slot n contains at least one flexible symbol (1204), is the slot where the period position of SR/SPS HARQ-ACK/CSI PUCCH is located (1203), and Slot m in the SCell and/or PCell is a DL slot that overlaps with Slot n in the time domain (1205). Therefore, Slot n may be considered a PUCCH slot (1207).

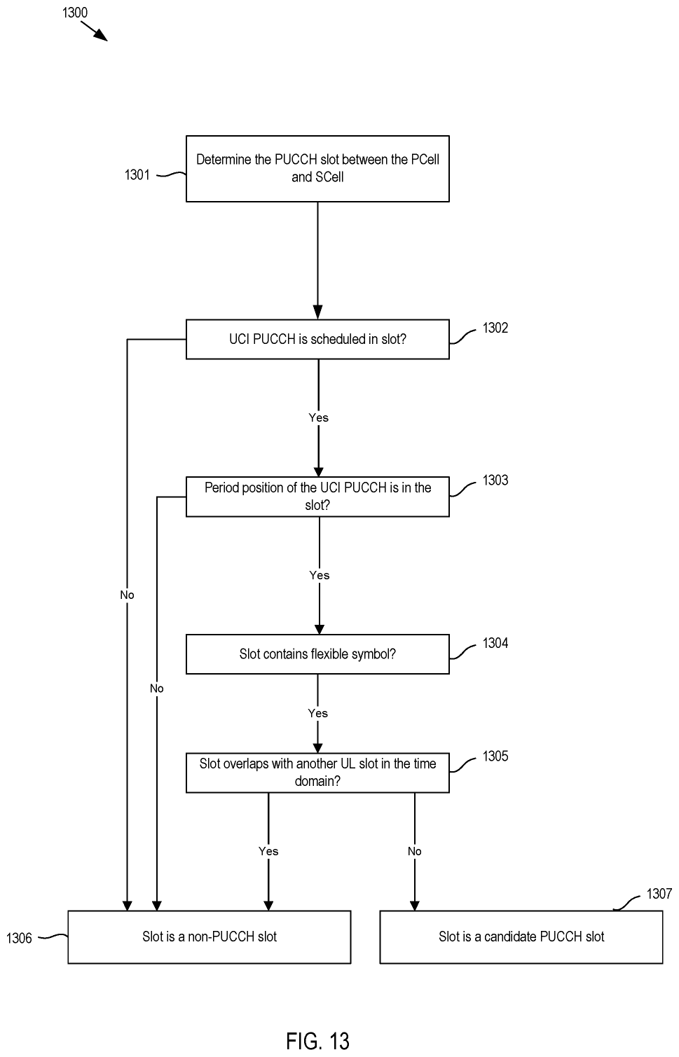

In connection with FIG. 13, a fifth rule 1300 for determining the PUCCH slot between the PCell and SCell is now described. In a PCell and/or an SCell for a slot containing at least one flexible symbol in 1304, if a UCI PUCCH is scheduled in 1302, the period position of the UCI PUCCH is in the slot in 1303, and if the slot overlaps with another UL slot in the time domain in 1305, then the slot may not be determined as a PUCCH slot in 1306. Another slot in the time domain overlapping the PUCCH slot may be allowed to be configured as a PUCCH slot in (1307). For example, an SR/SPS HARQ-ACK/CSI may be configured (1302), and the period position of the SR/SPS HARQ-ACK/CSI PUCCH may be in the PCell or SCell in Slot n (1303). Slot n may contain at least one flexible symbol (1304). Slot m in the SCell or PCell may be a UL slot, and Slot m and Slot n may overlap in the time domain (1305). If the wireless access node 104 attempts to configure a PUCCH slot from Slot n and Slot m, both the wireless access node 104 and the UE 102 may determine that Slot m may be considered a PUCCH slot (1307) while Slot n may not be determined to be a PUCCH slot (1306). According to this fifth rule, although Slot n contains at least one flexible symbol (1304) and is the slot where the period position of SR/SPS HARQ-ACK/CSI PUCCH is located (1303), Slot m in the SCell and/or PCell is a UL slot that overlaps with Slot n in the time domain (1305). Therefore, Slot m may be considered a PUCCH slot (1307) while Slot n may not be determined to be a PUCCH Slot (1306).

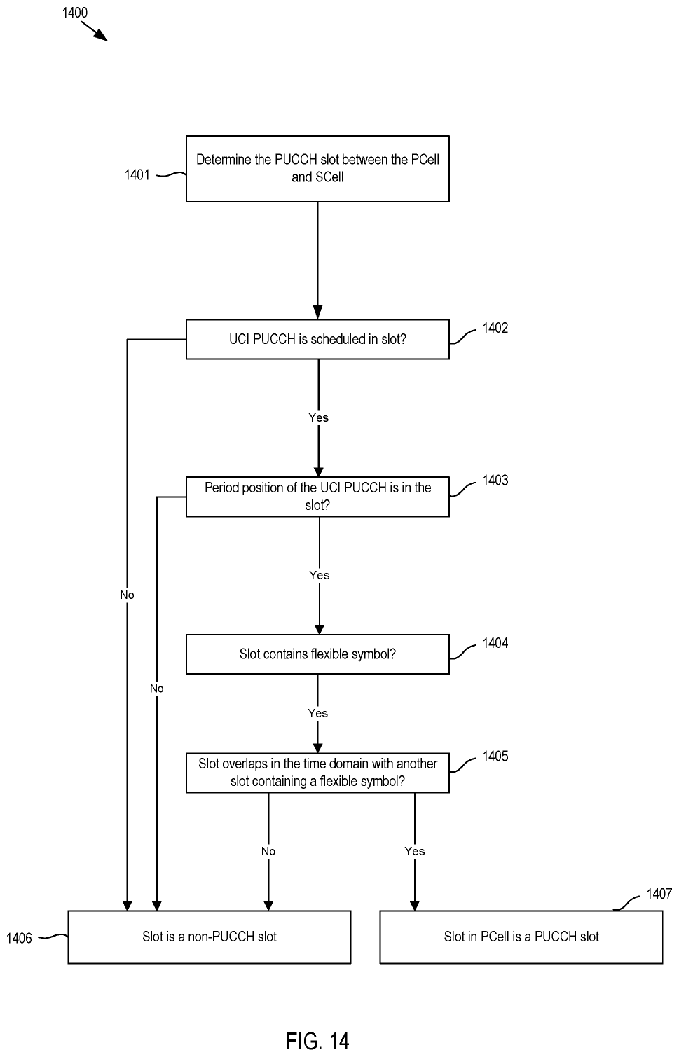

In connection with FIG. 14, a sixth rule 1400 for determining the PUCCH slot between the PCell and SCell is now described. In a PCell and/or an SCell for a slot containing at least one flexible symbol in 1404, if a UCI PUCCH is scheduled in 1402, the period position of the UCI PUCCH is in the slot in 1403, and if the slot overlaps with another slot containing one or more flexible symbols in the time domain in 1405, then only the slot in the PCell may be allowed to be determined as a PUCCH slot in 1407. For example, an SR/SPS HARQ-ACK/CSI may be configured (1402), and the period position of the SR/SPS HARQ-ACK/CSI PUCCH may be in the PCell or SCell in Slot n (1403). Slot n may contain at least one flexible symbol (1404). Slot m in the SCell or PCell may also contain at least one flexible symbol (1404), and Slot m and Slot n may overlap in the time domain (1405). If the wireless access node 104 attempts to configure a PUCCH slot from Slot n and Slot m, both the wireless access node 104 and the UE 102 may determine that the slot (n or m) in the PCell may be considered a PUCCH slot (1407) while the other slot may not be determined to be a PUCCH slot (1406).

Based on the rule-based approach(es) above, after the PUCCH slot is determined, the UCIs in the PCell and the SCell may be multiplexed into the determined PUCCH slot. The PUCCH of the multiplexing result may be determined from the PUCCH resource set corresponding to the cell where the PUCCH slot is located. In any of the previously-described techniques, if a PUCCH slot is configured or determined from Slot n and Slot m, then all UCIs in Slot n and Slot m may perform multiplexing. The PUCCH of the multiplexing result may be determined from the PUCCH resource set corresponding to the cell where the PUCCH slot is located.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: determining, with a wireless access node, a first slot for a first PUCCH and a second slot for a second PUCCH; and in response, processing, with the wireless access node, the second PUCCH based on positions of the first slot and the second slot and a time domain position of the second PUCCH relative to the first PUCCH, wherein the first PUCCH has a repetition factor greater than 1.

A second aspect includes a method for wireless communication that includes: determining, with a User Equipment (UE), a first slot for a first PUCCH and a second slot for a second PUCCH; and in response, processing, with the UE, the second PUCCH based on a position of the first slot and the second slot and a time domain position of the second PUCCH relative to the first PUCCH, wherein the first PUCCH has a repetition factor greater than 1.

A third aspect includes the method of the first or second aspects, wherein the second PUCCH is dynamically scheduled by the wireless access node.

A fourth aspect includes the method of any preceding aspect, wherein the second PUCCH is dynamically scheduled for the UE.

A fifth aspect includes the method of any preceding aspect, wherein the processing of the second PUCCH based on the positions of the first slot and the second slot and the time domain position of the second PUCCH relative to the first PUCCH, further comprises: if the second PUCCH dynamically scheduled or semi-statically configured would be in the second slot, and if the second slot and the first slot are the same slot, and if the second PUCCH and the first PUCCH are non-overlapping in the time domain, then prohibiting the wireless access node from scheduling or configuring the second PUCCH; or allowing the wireless access node to schedule or configure the second PUCCH, wherein the wireless access node does not expect to receive the second PUCCH.

A sixth aspect includes the method of any preceding aspect, wherein if the UE would transmit the dynamically scheduled or semi-statically configured second PUCCH in the second slot, and if the second slot and the first slot are the same slot, and if the second PUCCH and the first PUCCH are non-overlapping in the time domain, then the UE does not expect the second PUCCH to be dynamically scheduled or semi-statically configured in the second slot; or the method further comprises: canceling, with the UE, transmission of the second PUCCH.

A seventh aspect includes the method of any preceding aspect, wherein the processing of the second PUCCH based on the positions of the first slot and the second slot and the time domain position of the second PUCCH relative to the first PUCCH, further comprises: if the second PUCCH would be in the second slot, and if the second slot and the first slot are the same slot, and if the second PUCCH and the first PUCCH are non-overlapping in the time domain, and if the second PUCCH is dynamically scheduled, then prohibiting the wireless access node from scheduling the second PUCCH.

An eighth aspect includes the method of any preceding aspect, wherein if the UE would transmit the second PUCCH in the second slot, and if the second slot and the first slot are the same slot, and if the second PUCCH and the first PUCCH are non-overlapping in the time domain, and if the second PUCCH is dynamically scheduled, then the UE does not expect the second PUCCH to be dynamically scheduled in the second slot.

A ninth aspect includes the method of any preceding aspect, wherein the processing of the second PUCCH based on the positions of the first slot and the second slot and the time domain position of the second PUCCH relative to the first PUCCH, further comprises: if the second PUCCH would be in the second slot, and if the second slot and the first slot are the same slot, and if the second PUCCH and the first PUCCH are non-overlapping in the time domain, and if the second PUCCH is semi-statically configured, then allowing the wireless access node to configure the second PUCCH, wherein the wireless access node does not expect to receive the second PUCCH.

A tenth aspect includes the method of any preceding aspect, wherein the processing of the second PUCCH based on the positions of the first slot and the second slot and the time domain position of the second PUCCH relative to the first PUCCH, further comprises: if the UE would transmit the second PUCCH in the second slot, and if the second slot and the first slot are the same slot, and if the second PUCCH and the first PUCCH are non-overlapping in the time domain, and if the second PUCCH is semi-statically configured, then canceling, with the UE, transmission of the second PUCCH.

An eleventh aspect includes the method of any preceding aspect, further comprising: determining, with the wireless access node, that the first PUCCH and second PUCCH have a same or different physical priority; and determining, with the wireless access node, that the first PUCCH and second PUCCH have a same or different UCI type priority.

A twelfth aspect includes the method of any preceding aspect, wherein the first PUCCH comprises HARQ-ACK PUCCH, SR PUCCH or CSI PUCCH, the second PUCCH comprises HARQ-ACK PUCCH, SR PUCCH or CSI PUCCH, the HARQ-ACK PUCCH comprises a dynamically scheduled HARQ-ACK PUCCH or a semi-statically configured HARQ-ACK PUCCH, and the second PUCCH comprises a repetition factor greater than or equal to 1.

A thirteenth aspect includes the method of any preceding aspect, wherein the processing of the second PUCCH based on the positions of the first slot and the second slot and the time domain position of the second PUCCH relative to the first PUCCH, further comprises: if the second PUCCH would be dynamically scheduled or semi-statically configured in the second slot, and if the second slot and the first slot are the same slot, and if the second PUCCH and the first PUCCH are non-overlapping in the time domain, and if a UCI type priority for the second PUCCH is lower than the UCI type priority for first PUCCH, then allowing the wireless access node to schedule the second PUCCH, wherein the wireless access node does not expect to receive the second PUCCH.

A fourteenth aspect includes the method of any preceding aspect, wherein the processing of the second PUCCH based on the positions of the first slot and the second slot and the time domain position of the second PUCCH relative to the first PUCCH, further comprises: if the UE would transmit the dynamically scheduled or semi-statically configured second PUCCH in the second slot, and if the second slot and the first slot are the same slot, and if the second PUCCH and the first PUCCH are non-overlapping in the time domain, and if a UCI type priority for the second PUCCH is lower than the UCI type priority for first PUCCH, then canceling, with the UE, transmission of the second PUCCH.

A fifteenth aspect includes the method of any preceding aspect, wherein the processing of the second PUCCH based on the positions of the first slot and the second slot and the time domain position of the second PUCCH relative to the first PUCCH, further comprises: if the second PUCCH would be dynamically scheduled or semi-statically configured in the second slot, and if the second slot and the first slot are the same slot, and if the second PUCCH and the first PUCCH are non-overlapping in the time domain, and if a UCI type priority for the second PUCCH is higher than the UCI type priority for first PUCCH, then allowing the wireless access node to schedule the second PUCCH, wherein the wireless access node does not expect to receive the first PUCCH.

A sixteenth aspect includes the method of any preceding aspect, wherein the processing of the second PUCCH based on at least the positions of the first slot and the second slot and the time domain position of the second PUCCH relative to the first PUCCH, further comprises: if the UE would transmit the dynamically scheduled or semi-statically configured second PUCCH in the second slot, and if the second slot and the first slot are the same slot, and if the second PUCCH and the first PUCCH are non-overlapping in the time domain, and if a UCI type priority for the second PUCCH is higher than the UCI type priority for first PUCCH, then canceling, with the UE, transmission of the first PUCCH, and transmitting, with the UE, the second PUCCH.

A seventeenth aspect includes the method of any preceding aspect, wherein the processing of the second PUCCH based on the positions of the first slot and the second slot and the time domain position of the second PUCCH relative to the first PUCCH, further comprises: if the second PUCCH would be dynamically scheduled or semi-statically configured in the second slot, and if the second slot and the first slot are the same slot, and if the second PUCCH and the first PUCCH are non-overlapping in the time domain, and if a UCI type priority for the second PUCCH is lower than the UCI type priority for first PUCCH, then prohibiting the wireless access node from scheduling the second PUCCH.

An eighteenth aspect includes the method of any preceding aspect, wherein if the UE would transmit the dynamically scheduled or semi-statically configured second PUCCH in the second slot, and if the second slot and the first slot are the same slot, and if the second PUCCH and the first PUCCH are non-overlapping in the time domain, and if a UCI type priority for the second PUCCH is lower than the UCI type priority for first PUCCH, then the UE does not expect the second PUCCH to be in the second slot.

A nineteenth aspect includes the method of any preceding aspect, wherein the processing of the second PUCCH based on the positions of the first slot and the second slot and the time domain position of the second PUCCH relative to the first PUCCH, further comprises: if the second PUCCH would be dynamically scheduled or semi-statically configured in the second slot, and if the second slot and the first slot are the same slot, and if the second PUCCH and the first PUCCH are non-overlapping in the time domain, and if a UCI type priority for the second PUCCH is same as the UCI type priority for first PUCCH, then prohibiting the wireless access node from scheduling the second PUCCH.

A twentieth aspect includes the method of any preceding aspect, wherein if the UE would transmit the dynamically scheduled or semi-statically configured second PUCCH in the second slot, and if the second slot and the first slot are the same slot, and if the second PUCCH and the first PUCCH are non-overlapping in the time domain, and if a UCI type priority for the second PUCCH is same as the UCI type priority for first PUCCH, then the UE does not expect the second PUCCH to be in the second slot.

A twenty-first aspect includes the method of any preceding aspect, wherein the processing of the second PUCCH based on the positions of the first slot and the second slot and the time domain position of the second PUCCH relative to the first PUCCH, further comprises: if the second PUCCH would be dynamically scheduled or semi-statically configured in the second slot, and if the second slot and the first slot are the same slot, and if the second PUCCH and the first PUCCH are non-overlapping in the time domain, and if a UCI type priority for the second PUCCH is same as the UCI type priority for first PUCCH, then allowing the wireless access node to schedule the second PUCCH, wherein the wireless access node does not expect to receive the second PUCCH.

A twenty-second aspect includes the method of any preceding aspect, wherein the processing of the second PUCCH based on at least the positions of the first slot and the second slot and the time domain position of the second PUCCH relative to the first PUCCH, further comprises: if the UE would transmit the dynamically scheduled or semi-statically configured second PUCCH in the second slot, and if the second slot and the first slot are the same slot, and if the second PUCCH and the first PUCCH are non-overlapping in the time domain, and if a UCI type priority for the second PUCCH is same as the UCI type priority for first PUCCH, then canceling, with the UE, transmission of the second PUCCH, and transmitting the first PUCCH.

A twenty-third aspect includes a method for wireless communication, including configuring, with a wireless access node, PUCCH cell switching between a first cell and a second cell; and determining, with the wireless access node, a slot configured as a period position of a UCI PUCCH to be a PUCCH slot or not be a PUCCH slot based on a symbol type contained in the slot, wherein the symbol type comprises: a downlink symbol, an uplink symbol, or a flexible symbol, the slot is in one of the first cell or the second cell, and the UCI PUCCH comprises: HARQ-ACK, SR, or CSI.

A twenty-fourth aspect includes a method for wireless communication, the method including determining, by a UE, PUCCH cell switching between first cell and second cell; and determining, by the UE, a slot configured as a period position of a UCI PUCCH to be a PUCCH slot or not be a PUCCH slot based on a symbol type contained in the slot, wherein the symbol type comprises: a downlink symbol, an uplink symbol, or a flexible symbol, the slot is in one of the first cell or the second cell, and the UCI PUCCH comprises: HARQ-ACK, SR, or CSI.

A twenty-fifth aspect includes the method of aspects 23 or 24, wherein all symbols contained in the slot are downlink symbols, the slot is not configured as the PUCCH slot in response to the slot containing only a plurality of downlink symbols, another slot that overlaps the slot in a time domain is allowed to be indicated as a PUCCH slot if the another slot contains uplink symbols or flexible symbols, and the another slot is in the other of the first cell and the second cell.

A twenty-sixth aspect includes the method of aspects 23-25, wherein the slot contains at least one symbol that is the flexible symbol, the slot is not configured as the PUCCH slot in response to the slot containing at least one flexible symbol, another slot that overlaps the slot in a time domain is allowed to be indicated as a PUCCH slot if the another slot contains uplink symbols or flexible symbols, and the another slot is in the other of the first cell and the second cell.

A twenty-seventh aspect includes the method of aspects 23-26, wherein the slot contains at least one symbol that is the flexible symbol, the slot is configured as the PUCCH slot in response to the slot containing at least one flexible symbol, another slot that overlaps the slot in a time domain is not allowed to be indicated as a PUCCH slot even if the another slot contains uplink symbols or flexible symbols, and the another slot is in the other of the first cell and the second cell.

A twenty-eighth aspect includes the method of aspects 23-27, wherein the slot contains at least one symbol that is the flexible symbol, and the slot is configured as the PUCCH slot in response to all symbols contained in another slot being downlink symbols, and the another slot overlaps the slot in a time domain and is in the other of the first cell and the second cell.

A twenty-ninth aspect includes the method of aspects 23-28, wherein the slot contains at least one symbol that is the flexible symbol, and the slot is not configured as the PUCCH slot in response to all symbols contained in another slot being uplink symbols, the another slot overlaps the slot in a time domain and is in the other of the first cell and the second cell, and the another slot is allowed to be indicated as a PUCCH slot.

A thirtieth aspect includes the method of aspects 23-29, wherein the slot contains at least one symbol that is the flexible symbol, the slot is configured as the PUCCH slot in response to another slot containing at least one flexible symbol, and the another slot overlaps the slot in a time domain and is in the other of the first cell and the second cell.

A thirty-first aspect includes the method of aspects 23-30, wherein the slot contains at least one symbol that is the flexible symbol, another slot contains at least one symbol that is the flexible symbol, and if a first slot is from the slot and the another slot and is in a PCell, then the first slot is indicated as a PUCCH slot, wherein the another slot overlaps the slot in a time domain, and is in the other of the first cell and the second cell.

A thirty-second aspect includes a wireless communications apparatus including processor and a memory, wherein the processor is configured to read code from the memory to implement a method of any preceding aspect.

A thirty-third aspect includes a computer program product comprising a computer-readable program medium comprising code stored thereupon, the code, when executed by a processor, causing the processor to implement a method of aspects 1-31.

In addition to the features mentioned in each of the independent aspects enumerated above, some examples may show, alone or in combination, the optional features mentioned in the dependent aspects and/or as disclosed in the description above and shown in the figures.

1. A method for wireless communication, comprising:
determining, with a wireless access node, a first slot for a first PUCCH and a second slot for a second PUCCH; and in response,
processing, with the wireless access node, the second PUCCH based on positions of the first slot and the second slot and a time domain position of the second PUCCH relative to the first PUCCH, wherein
the first PUCCH has a repetition factor greater than 1.

2. A method for wireless communication, comprising:
determining, with a User Equipment (UE), a first slot for a first PUCCH and a second slot for a second PUCCH; and in response,
processing, with the UE, the second PUCCH based on a position of the first slot and the second slot and a time domain position of the second PUCCH relative to the first PUCCH, wherein
the first PUCCH has a repetition factor greater than 1.

3. The method of claim 1, wherein
the second PUCCH is dynamically scheduled by the wireless access node.

4. The method of claim 2, wherein
the second PUCCH is dynamically scheduled for the UE.

5. The method of claim 1, wherein the processing of the second PUCCH based on the positions of the first slot and the second slot and the time domain position of the second PUCCH relative to the first PUCCH, further comprises:
if the second PUCCH dynamically scheduled or semi-statically configured would be in the second slot, and if the second slot and the first slot are the same slot, and if the second PUCCH and the first PUCCH are non-overlapping in the time domain, then
prohibiting the wireless access node from scheduling or configuring the second PUCCH; or
allowing the wireless access node to schedule or configure the second PUCCH, wherein
the wireless access node does not expect to receive the second PUCCH.

6. The method of claim 2, wherein
if the UE would transmit the dynamically scheduled or semi-statically configured second PUCCH in the second slot, and if the second slot and the first slot are the same slot, and if the second PUCCH and the first PUCCH are non-overlapping in the time domain, then the UE does not expect the second PUCCH to be dynamically scheduled or semi-statically configured in the second slot; or the method further comprises:
canceling, with the UE, transmission of the second PUCCH.

7. The method of claim 1, wherein the processing of the second PUCCH based on the positions of the first slot and the second slot and the time domain position of the second PUCCH relative to the first PUCCH, further comprises:
if the second PUCCH would be in the second slot, and if the second slot and the first slot are the same slot, and if the second PUCCH and the first PUCCH are non-overlapping in the time domain, and if the second PUCCH is dynamically scheduled, then
prohibiting the wireless access node from scheduling the second PUCCH.

8. The method of claim 2, wherein
if the UE would transmit the second PUCCH in the second slot, and if the second slot and the first slot are the same slot, and if the second PUCCH and the first PUCCH are non-overlapping in the time domain, and if the second PUCCH is dynamically scheduled, then the UE does not expect the second PUCCH to be dynamically scheduled in the second slot.

9. The method of claim 1, wherein the processing of the second PUCCH based on the positions of the first slot and the second slot and the time domain position of the second PUCCH relative to the first PUCCH, further comprises:
if the second PUCCH would be in the second slot, and if the second slot and the first slot are the same slot, and if the second PUCCH and the first PUCCH are non-overlapping in the time domain, and if the second PUCCH is semi-statically configured, then
allowing the wireless access node to configure the second PUCCH, wherein the wireless access node does not expect to receive the second PUCCH.

10. The method of claim 2, wherein the processing of the second PUCCH based on the positions of the first slot and the second slot and the time domain position of the second PUCCH relative to the first PUCCH, further comprises:
if the UE would transmit the second PUCCH in the second slot, and if the second slot and the first slot are the same slot, and if the second PUCCH and the first PUCCH are non-overlapping in the time domain, and if the second PUCCH is semi-statically configured, then
canceling, with the UE, transmission of the second PUCCH.

11. The method of claim 1, further comprising:
determining, with the wireless access node, that the first PUCCH and second PUCCH have a same or different physical priority; and
determining, with the wireless access node, that the first PUCCH and second PUCCH have a same or different UCI type priority.

12. The method of claim 1, wherein
the first PUCCH comprises HARQ-ACK PUCCH, SR PUCCH or CSI PUCCH,
the second PUCCH comprises HARQ-ACK PUCCH, SR PUCCH or CSI PUCCH,
the HARQ-ACK PUCCH comprises a dynamically scheduled HARQ-ACK PUCCH or a semi-statically configured HARQ-ACK PUCCH, and
the second PUCCH comprises a repetition factor greater than or equal to 1.

13. The method of claim 1, wherein the processing of the second PUCCH based on the positions of the first slot and the second slot and the time domain position of the second PUCCH relative to the first PUCCH, further comprises:
if the second PUCCH would be dynamically scheduled or semi-statically configured in the second slot, and if the second slot and the first slot are the same slot, and if the second PUCCH and the first PUCCH are non-overlapping in the time domain, and if a UCI type priority for the second PUCCH is lower than the UCI type priority for first PUCCH, then
allowing the wireless access node to schedule the second PUCCH, wherein the wireless access node does not expect to receive the second PUCCH.

14. The method of claim 2, wherein the processing of the second PUCCH based on the positions of the first slot and the second slot and the time domain position of the second PUCCH relative to the first PUCCH, further comprises:
if the UE would transmit the dynamically scheduled or semi-statically configured second PUCCH in the second slot, and if the second slot and the first slot are the same slot, and if the second PUCCH and the first PUCCH are non-overlapping in the time domain, and if a UCI type priority for the second PUCCH is lower than the UCI type priority for first PUCCH, then
canceling, with the UE, transmission of the second PUCCH.

15. The method of claim 1, wherein the processing of the second PUCCH based on the positions of the first slot and the second slot and the time domain position of the second PUCCH relative to the first PUCCH, further comprises:
if the second PUCCH would be dynamically scheduled or semi-statically configured in the second slot, and if the second slot and the first slot are the same slot, and if the second PUCCH and the first PUCCH are non-overlapping in the time domain, and if a UCI type priority for the second PUCCH is higher than the UCI type priority for first PUCCH, then
allowing the wireless access node to schedule the second PUCCH, wherein the wireless access node does not expect to receive the first PUCCH.

16. The method of claim 2, wherein the processing of the second PUCCH based on at least the positions of the first slot and the second slot and the time domain position of the second PUCCH relative to the first PUCCH, further comprises:
if the UE would transmit the dynamically scheduled or semi-statically configured second PUCCH in the second slot, and if the second slot and the first slot are the same slot, and if the second PUCCH and the first PUCCH are non-overlapping in the time domain, and if a UCI type priority for the second PUCCH is higher than the UCI type priority for first PUCCH, then
canceling, with the UE, transmission of the first PUCCH, and
transmitting, with the UE, the second PUCCH.

17. The method of claim 1, wherein the processing of the second PUCCH based on the positions of the first slot and the second slot and the time domain position of the second PUCCH relative to the first PUCCH, further comprises:
if the second PUCCH would be dynamically scheduled or semi-statically configured in the second slot, and if the second slot and the first slot are the same slot, and if the second PUCCH and the first PUCCH are non-overlapping in the time domain, and if a UCI type priority for the second PUCCH is lower than the UCI type priority for first PUCCH, then
prohibiting the wireless access node from scheduling the second PUCCH.

18. The method of claim 2, wherein
if the UE would transmit the dynamically scheduled or semi-statically configured second PUCCH in the second slot, and if the second slot and the first slot are the same slot, and if the second PUCCH and the first PUCCH are non-overlapping in the time domain, and if a UCI type priority for the second PUCCH is lower than the UCI type priority for first PUCCH, then the UE does not expect the second PUCCH to be in the second slot.

19. The method of claim 1, wherein the processing of the second PUCCH based on the positions of the first slot and the second slot and the time domain position of the second PUCCH relative to the first PUCCH, further comprises:
if the second PUCCH would be dynamically scheduled or semi-statically configured in the second slot, and if the second slot and the first slot are the same slot, and if the second PUCCH and the first PUCCH are non-overlapping in the time domain, and if a UCI type priority for the second PUCCH is same as the UCI type priority for first PUCCH, then
prohibiting the wireless access node from scheduling the second PUCCH.

20. The method of claim 2, wherein if the UE would transmit the dynamically scheduled or semi-statically configured second PUCCH in the second slot, and if the second slot and the first slot are the same slot, and if the second PUCCH and the first PUCCH are non-overlapping in the time domain, and if a UCI type priority for the second PUCCH is same as the UCI type priority for first PUCCH, then the UE does not expect the second PUCCH to be in the second slot.
